(19) United States
(12) Patent Application Publication
(10) Pub. No.: US 2026/0166702 A1
(43) Pub. Date: Jun. 18, 2026

(54) SPRING-BASED LODGED OBJECT REMOVAL

(71) Applicant: Scott Greenhalgh, Logan, UT (US)

(72) Inventor: Scott Greenhalgh, Logan, UT (US)

(73) Assignee: Utah State University, Logan, UT (US)

(21) Appl. No.: 19/422,300

(22) Filed: Dec. 16, 2025

Related U.S. Application Data
(60) Provisional application No. 63/734,655, filed on Dec. 16, 2024.

(51) Int. Cl. B25F 1/00; A63B 29/02

(52) U.S. Cl. CPC B25F 1/006; A63B 29/024

(57) ABSTRACT

Examples of the present disclosure include an apparatus. The apparatus includes a first elongated member and a tool coupled to an end of the first elongated member. The apparatus includes a spring. The spring includes a first spring end coupled to the first elongated member and a second spring end opposite to the first spring end. The apparatus includes a second elongated member coupled to the second spring end such that the second elongated member moving toward the first elongated member causes elastic deformation of the spring.

### CROSS-REFERENCE TO RELATED APPLICATIONS

The application claims the benefit of U.S. Provisional Patent Application Number 63/734,655 entitled “LODGED OBJECT REMOVAL APPARATUS” and filed on Dec. 16, 2024, for Scott Greenhalgh, which is incorporated herein by reference.

### FIELD

This invention relates to removal of lodged objects and more particularly relates to apparatuses and methods for spring-based lodged objected removal.

### BACKGROUND

In various outdoor, industrial, and recreational environments, objects can become tightly lodged within narrow crevices, cavities, or irregular surfaces. For example, debris, fasteners, or protective components may become wedged into gaps formed in structural elements, rock faces, or mechanical assemblies. In the context of climbing and mountaineering activities, protective devices such as rock climbing nuts, wedges, or other passive protection can become firmly seated within cracks or fissures during use. A climber typically places these devices to arrest a fall, and are intentionally set in a stable position.

### SUMMARY

Examples of the present disclosure include an apparatus. The apparatus includes a first elongated member and a tool coupled to an end of the first elongated member. The apparatus includes a spring. The spring includes a first spring end coupled to the first elongated member and a second spring end opposite to the first spring end. The apparatus includes a second elongated member coupled to the second spring end such that the second elongated member moving toward the first elongated member causes elastic deformation of the spring.

In some examples, an apparatus includes a first elongated member and a tool coupled to an end of the first elongated member. The tool includes a tip located beyond the first elongated member. The apparatus includes a spring. The spring includes a first spring end coupled to the first elongated member and a second spring end opposite to the first spring end. The apparatus includes a second elongated member within which the first elongated ember is at least partially disposed. The second elongated member is configured to move translationally with respect to the first elongated member. The second elongated member is coupled to the second spring end such that the second elongated member moving towards the first elongated member causes elastic deformation of the spring and a transfer of a momentum force to the first elongated member and to the tip.

In some examples, an apparatus includes a first elongated member and a tool coupled to an end of the first elongated member. The tool includes a tip located beyond the first elongated member. The tool includes at least one of: a hook, a pick, a key, a hammer head, and/or a knife. The apparatus includes a spring. The spring includes a first spring end coupled to the first elongated member and a second spring end opposite to the first spring end. The apparatus includes a second elongated member within which the first elongated member is at least partially disposed. The second elongated member is configured to move translationally with respect to the first elongated member and is coupled to the second spring end such that the second elongated member moving toward the first elongated member causes elastic deformation of the spring and a transfer of a momentum force to the first elongated member and to the tip. The apparatus includes a locking mechanism extending through a thickness of the second elongated member and configured to engage with the first elongated member to hold the second elongated member in a position to maintain elastic deformation of the spring. The apparatus includes a cap disposed over an end of the second elongated member. The cap has a maximum width greater than a maximum width of the second elongated member. The apparatus includes a line threaded through the cap and extending through the second elongated member and into the first elongated member. An end of the line is fixed within the first elongated member. The apparatus includes an inner tube disposed within the first elongated member and including an opening. The line extends through the inner tube and through the opening. The first elongated member is substantially concentric with respect to at least one of the inner tube, the second elongated member, and the cap.

### BRIEF DESCRIPTION OF THE DRAWINGS

In order that the advantages of the invention will be readily understood, a more particular description of the invention briefly described above will be rendered by reference to specific examples that are illustrated in the appended drawings. Understanding that these drawings depict only typical examples of the invention and are not therefore to be considered to be limiting of its scope, the invention will be described and explained with additional specificity and detail through the use of the accompanying drawings, in which:

FIG. 1A is a cross-sectional view illustrating a lodged object removal apparatus approaching a lodged object from a first angle, according to various embodiments;

FIG. 1B is a cross-sectional view illustrating a lodged object removal apparatus approaching a lodged object from another angle, according to various embodiments;

FIG. 2A is a side view illustrating one example of a lodged object removal apparatus, according to various embodiments;

FIG. 2B is a transparent perspective view illustrating the lodged object removal apparatus of FIG. 2A, according to various embodiments;

FIG. 2C is a perspective view illustrating the lodged object removal apparatus of FIG. 2A, according to various embodiments;

FIG. 2D is a perspective view illustrating a collapsed position of the lodged object removal apparatus of FIG. 2A, according to various embodiments;

FIG. 2E is a cross-sectional view of an end and tool of the lodged object removal apparatus of FIG. 2A, according to various embodiments;

FIG. 2F is a cross-sectional view of a portion of the lodged object removal apparatus of FIG. 2A, according to various embodiments;

FIG. 2G is a cross-sectional view of an end and end cap of the lodged object removal apparatus of FIG. 2A, according to various embodiments;

FIG. 2H is a cross-sectional view of the lodged object removal apparatus of FIG. 2A, with a locking mechanism in place, according to various embodiments;

FIG. 3 is a side view illustrating a lodged object removal apparatus having an elongated tool, according to various embodiments; and

FIG. 4 is a schematic flow chart diagram illustrating a method of forming a lodged object removal apparatus, according to various embodiments.

### DETAILED DESCRIPTION

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more examples. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the examples may be combined in any suitable manner. One skilled in the relevant art will recognize that the examples may be practiced without one or more of the specific features or advantages of a particular example. In other instances, additional features and advantages may be recognized in certain examples that may not be present in all examples.

These features and advantages of the examples will become more fully apparent from the following description and appended claims, or may be learned by the practice of examples as set forth hereinafter.

The description of elements in each figure may refer to elements of proceeding figures. Like numbers refer to like elements in all figures, including alternate examples of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

Examples of the present disclosure include an apparatus. The apparatus includes a first elongated member and a tool coupled to an end of the first elongated member. The apparatus includes a spring. The spring includes a first spring end coupled to the first elongated member and a second spring end opposite to the first spring end. The apparatus includes a second elongated member coupled to the second spring end such that the second elongated member moving toward the first elongated member causes elastic deformation of the spring.

In some examples, the spring is disposed within the second elongated member. In some examples, the apparatus includes a locking mechanism extending through a thickness of the second elongated member and configured to engage with the first elongated member to hold the second elongated member in a position to maintain elastic deformation of the spring.

In some examples, the apparatus includes a cap disposed over an end of the second elongated member. The cap has a maximum width greater than a maximum width of the second elongated member. In some examples, the apparatus includes a line threaded through the cap and extending through the second elongated member and into the first elongated member. The end of the line is fixed within the first elongated member. The apparatus includes an inner tube disposed within the first elongated member. The inner tube includes an opening. The line extends through the inner tube and through the opening. The apparatus includes a stopper disposed within the first elongated member and connected directly to the line. The stopper has a maximum width greater than a maximum width of the opening. The first elongated member is substantially concentric with at least one of the inner tube, the second elongated member, and the cap.

In some examples, the second elongated member is configured to strike the first elongated member, transferring a momentum force to the first elongated member and to a tip of the tool located beyond the first elongated member. In some examples, the tool includes a tip located beyond the first elongated member, and the second elongated member is configured to transfer a momentum force to the first elongated member and to the tip by moving towards the first elongated member. In some examples, the tool includes at least one of a hook a pick, a key, a hammer head, and/or a knife. In some examples, the first elongated member is at least partially disposed within he second elongated member. In some examples, the second elongated member is configured to move translationally with respect to the first elongated member. In some examples, the first elongated member and the tool are of a monolithic construction.

In some examples, the first elongated member includes a first portion and a connecting member fixedly coupled to and enclosing an outer perimeter of the first portion. The first spring end is coupled directly to the connecting member and the second spring end is coupled directly to the second elongated member. In some examples, the first elongated member further includes a second portion coupled to the connecting member. The spring surrounds the second portion, and the second elongated member at least partially encloses the second portion and is configured to telescope with the second portion. In some examples, a ratio of a width of the second elongated member to a width of the second portion is between and inclusive of 1.001 and 2.0. In some examples, the tool includes an opening extending through a thickness of the tool and a plurality of ridges projecting radially inward into the opening. The plurality of ridges are spaced circumferentially around the opening. In some examples, the second elongated member is disposed at least partially within the tool and is configured to move translationally with respect to the tool.

In some examples, an apparatus includes a first elongated member and a tool coupled to an end of the first elongated member. The tool includes a tip located beyond the first elongated member. The apparatus includes a spring. The spring includes a first spring end coupled to the first elongated member and a second spring end opposite to the first spring end. The apparatus includes a second elongated member within which the first elongated ember is at least partially disposed. The second elongated member is configured to move translationally with respect to the first elongated member. The second elongated member is coupled to the second spring end such that the second elongated member moving towards the first elongated member causes elastic deformation of the spring and a transfer of a momentum force to the first elongated member and to the tip.

In some examples, an apparatus includes a first elongated member and a tool coupled to an end of the first elongated member. The tool includes a tip located beyond the first elongated member. The tool includes at least one of: a hook, a pick, a key, a hammer head, and/or a knife. The apparatus includes a spring. The spring includes a first spring end coupled to the first elongated member and a second spring end opposite to the first spring end. The apparatus includes a second elongated member within which the first elongated member is at least partially disposed. The second elongated member is configured to move translationally with respect to the first elongated member and is coupled to the second spring end such that the second elongated member moving toward the first elongated member causes elastic deformation of the spring and a transfer of a momentum force to the first elongated member and to the tip. The apparatus includes a locking mechanism extending through a thickness of the second elongated member and configured to engage with the first elongated member to hold the second elongated member in a position to maintain elastic deformation of the spring. The apparatus includes a cap disposed over an end of the second elongated member. The cap has a maximum width greater than a maximum width of the second elongated member. The apparatus includes a line threaded through the cap and extending through the second elongated member and into the first elongated member. An end of the line is fixed within the first elongated member. The apparatus includes an inner tube disposed within the first elongated member and including an opening. The line extends through the inner tube and through the opening. The first elongated member is substantially concentric with respect to at least one of the inner tube, the second elongated member, and the cap.

Objects can be lodged in various applications, such as rock climbing, other recreational activities, construction, and engineering. For example, in rock climbing, passive protection devices such as nuts or cams can be used to help safeguard climbers. To place a nut, a climber jams it into a crack in the rock, relying on friction to hold the nut in place. The nut's shape and/or size is chosen to fit the specific crack. The climber may attach a sling or runner to the nut for protection. The sling or runner can then be clipped to the climber's harness, creating a protective anchor. This allows climbers to place protection within natural features (e.g., cracks) rather than relying on pre-placed bolts.

Lodged objects may eventually need to be removed. For example, after a climber has completed a climb and is rappelling down the route, they will dislodge the lodged nut. Examples of the present disclosure include an apparatus for removing a lodged object that helps the user to more efficiently apply force to the lodged object. Examples of the present disclose include designs for apparatuses that help to improve compactness and portability.

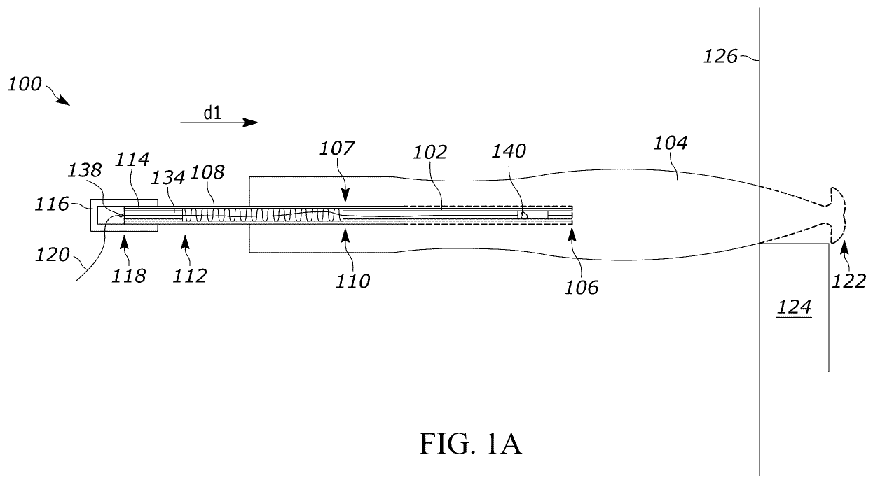

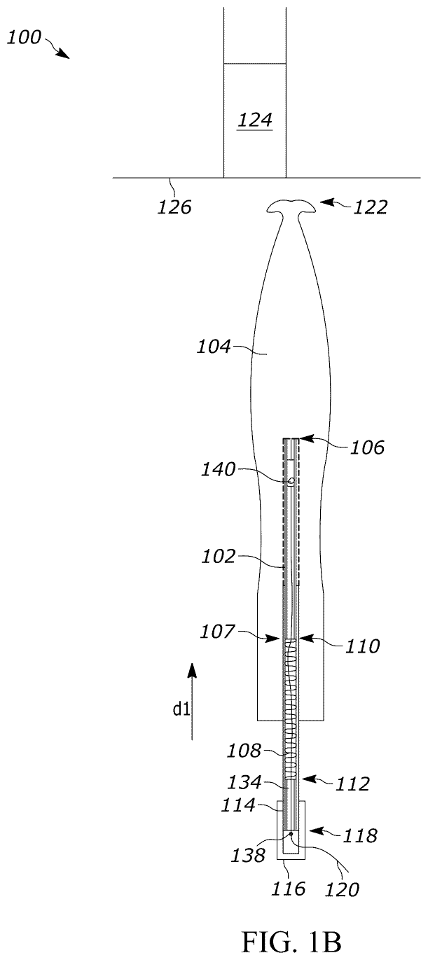

FIG. 1A is a cross-sectional view illustrating a lodged object removal apparatus 100, according to various embodiments. The apparatus 100 includes a first elongated member 102, a tool 104, a spring 108, and a second elongated member 114. In some examples, the apparatus 100 also includes a cap 116 and/or a line 120. In some examples, the apparatus 100 is configured to help remove a lodged object 124 from a material 126 by moving the second elongated member 114 in a first direction d1 to transfer force into and through the first elongated member 102 and to a tip 122 of the tool 104 to move the lodged object 124.

In some examples, the spring 108 is disposed between and/or connected to the first elongated member 102 and the second elongated member 114. In some examples, the spring 108 is disposed at least partially within the second elongated member 114. According to some examples, the spring 108 is completely disposed within the second elongated member 114. In some examples, the second elongated member 114 is configured to slide towards and/or with respect to the first elongated member 102, and the spring transfers force from the second elongated member 114 and into the lodged object 124 to displace the lodged object 124.

In some examples, a user slams an end of the second elongated member 114 to transfer force in the first direction d1 through the first elongated member 102, through the tool 104, and into the lodged object 124. In some examples, the first direction d1 of force transfer is substantially parallel to a length of the first elongated member 102 and/or a length of the second elongated member 114. In other examples, the user places the tool 104 in contact with the lodged object 124 and applies force in a direction opposite to the first direction d1, thus pulling the lodged object 124 in a direction outward from a surface of the material 126. Referring to FIG. 1A, in some examples, the apparatus 100 is configured to exert a force on a lodged object 124 by the second elongated member 114 moving in a direction d1 substantially perpendicular to a surface of the material 126. In some examples, the second elongated member 114 approaches the lodged object 124 from the side. Referring to FIG. 1B, in some examples, the apparatus 100 is configured to exert a force on the lodged object 124 by approaching the lodged object 124 and the material from below. In various examples, the apparatus 100 is configured to impart a force proximate to a corner or an edge of the lodged object 124.

In some examples, the apparatus 100 includes a tool 104 coupled to an end 106 of the first elongated member 102. In some examples, the tool 104 is shaped to help dislodge the lodged object 124. In some examples, the tool 104 is configured to hook onto, leverage, and/or pull a portion of the lodged object 124. In some examples, the tool 104 includes at least one of: a pick, a key, a hammer head, a knife, a curved edge, a hook, a wrench, a screwdriver, pliers, a blade, a screw, a point, a nut splitter, and/or another similar tool. In some examples, a user may move and/or apply force to the tool 104 to remove a lodged object 124 lodged within a material 126, such as a nut lodged within a crack in a rock. In some examples, the tool 104 is configured to contact the lodged object 124 while it is lodged in the material 126.

In some examples, the second elongated member 114 is configured to transfer a momentum force through the first elongated member 102 and to the tip 122 of the tool 104 located beyond the first elongated member 102. In some examples, by transferring the momentum force to the tip 122, the second elongated member 114 transfers the momentum force to the lodged object 124 in contact with the tip 122. In some examples, the second elongated member 114 is configured to transfer the momentum force by striking the first elongated member 102. In some examples, the spring 108 is disposed around at least a portion of the first elongated member 102 and/or second elongated member 114 and/or has a stiffness low enough to allow the second elongated member 114 (e.g., the interior portion 134) to strike the first elongated member 102 when the spring 108 is compressed.

According to some examples, the second elongated member 114 is configured to move towards the first elongated member 102 and strike the first elongated member 102, transferring a momentum force to the first elongated member 102 and to a tip 122 of the tool 104 that is located beyond the first elongated member 102. In some examples, the second elongated member 114 is configured to move translationally with respect to the first elongated member 102. According to various examples, the apparatus 100 is configured to telescope via the translational movement.

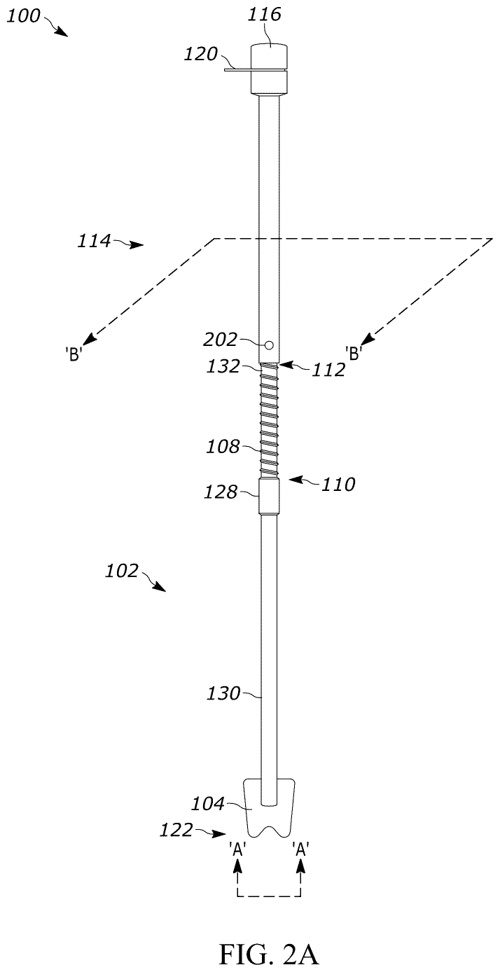

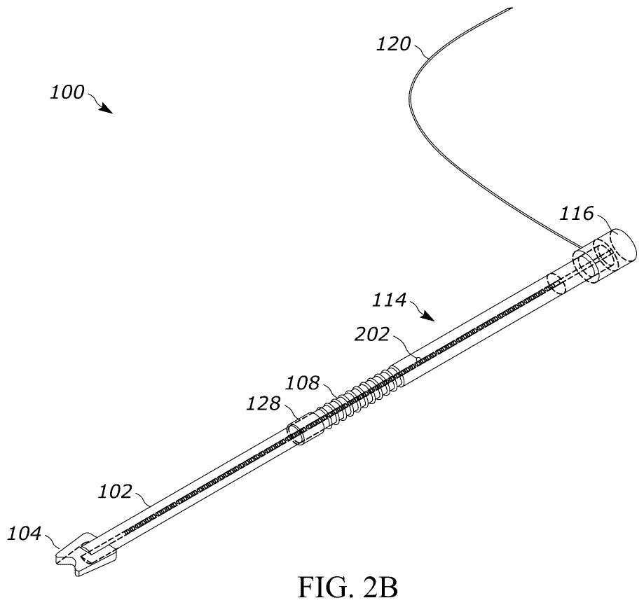

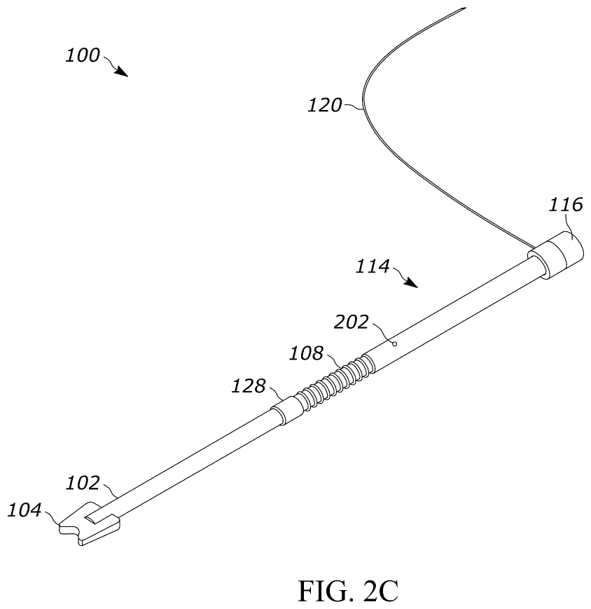

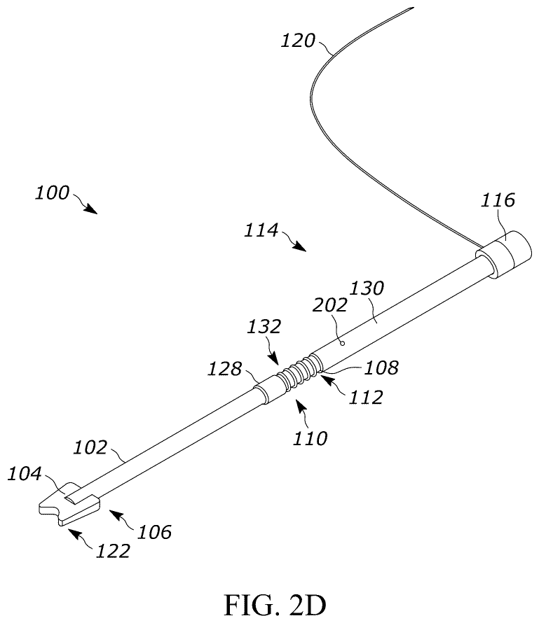

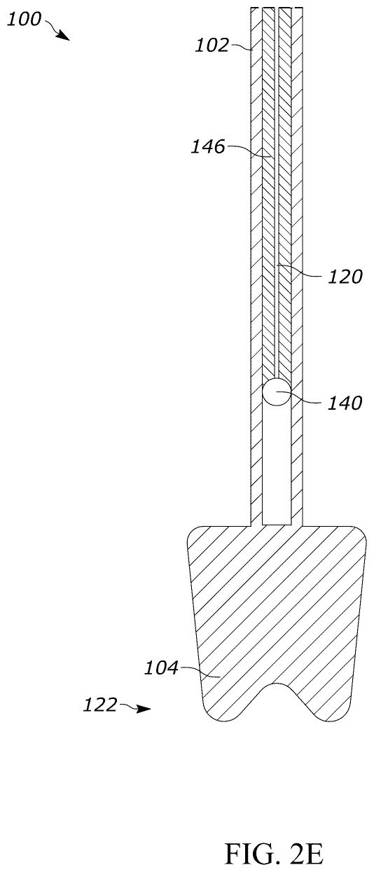

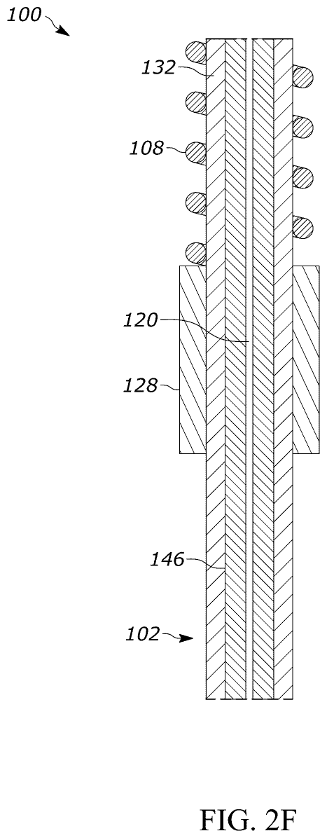

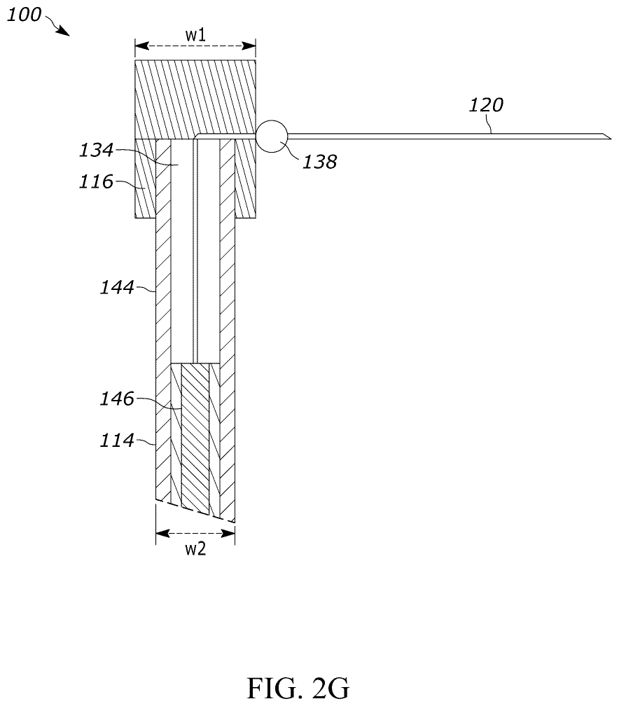

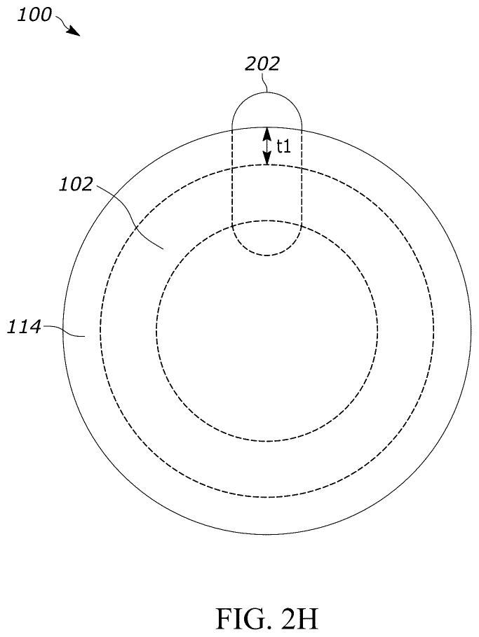

In some examples, the first elongated member 102 is coupled to the tool 104. In some examples, the first elongated member 102 is fixedly coupled to the tool 104. In one or more examples, the first elongated member 102 is disposed at least partially within the tool 104. In various examples, the first elongated member 102 and the tool 104 are of a monolithic construction. Referring to FIGS. 1A-B, in some examples, the first elongated member 102 is enveloped by the tool 104. Referring to FIGS. 2A-H and 3, in some examples, the first elongated member 102 is not disposed within or is only partially disposed within the tool 104. In various examples, the tool 104 is removable from the first elongated member 102.

According to some examples, the tool 104 is interchangeable. In some examples, a plurality of different tools 104 are selectively couplable to the first elongated member 102. Such tools 104 can be exchanged based on a type, size, orientation, and/or engagement profile of the lodged object 124. According to one or more examples, the interchangeable tools 104 include tools 104 having differing shapes, dimensions, geometries, surface textures, gripping features, and/or engagement mechanisms. In some examples, the tool 104 is removably coupled to the first elongated member 102 via a threaded connection, snap-fit connection, friction fit, bayonet-style coupling, detent mechanism, mating features, and/or other releasable mechanical interface. According to some examples, the apparatus 100 can be reconfigured for different removal tasks by replacing the tool 104 without replacing the first elongated member 102.

In one or more examples, a tip 122 of the tool 104 extends in the first direction d1 beyond a first end 106 of the first elongated member 102 to which the tool 104 is coupled. Referring to FIGS. 1A and 1B, in some examples, a length of the tool 104 is greater than a length of the first elongated member 102 in the first direction d1. Referring to FIGS. 2A-D, in other examples, a length of the first elongated member 102 is greater than the length of the tool 104 in the first direction d1. In some examples, the elongated member 102 has a length in the direction d1 that is greater than its maximum width in a perpendicular direction. In some examples, the first elongated member 102 is shaped substantially similar to a tube, a cylinder, a rectangular prism, a triangular prism, or a combination thereof. In various examples, the first elongated member 102 is at least partially hollow and/or tubular shaped. In other examples, the first elongated member 102 is filled. In one or more examples, the first elongated member is made of at least one of: a metallic material, steel, carbon fiber, iron, chrome, aluminum, fiberglass, or the like, or a combination thereof.

In some examples, the spring 108 is coupled to the first elongated member 102 and is configured to transfer force into and/or through the first elongated member 102. In some examples, the spring 108 includes a first spring end 110 that is fixedly coupled to the first elongated member 102. In one or more examples, the first spring end 110 is adhered to the first elongated member 102. In some examples, the first spring end 110 is fixedly coupled to the first elongated member 102 proximate to a second end 107 opposite to the first end 106. In various examples, the spring 108 is coiled around at least a portion of the first elongated member 102.

The apparatus 100 includes a second elongated member 114 coupled to or in contact with a second spring end 112 opposite to the first spring end 110 such that the second elongated member 114 moving toward the first elongated member 102 causes elastic deformation (e.g., compression) of the spring 108. Referring to FIGS. 1A and 1B, in some examples, the spring 108 is completely encompassed by the second elongated member 114, and the first elongated member 102 is disposed at least partially within the second elongated member 114. In some examples, the second elongated member 114 moves with respect to the first elongated member 102, and the tool 104 to compress the spring 108. In some examples, the spring 108 is of a stiffness sufficient to maintain displacement between the second elongated member 114 and the end 106 in the equilibrium position, while still allowing the movement of the second elongated member 114 towards the end 106 when compressed. Referring to FIGS. 1A and 1B, in some examples, the second elongated member 114 moves within the tool 104 in the direction d1. As such, in some examples, the second elongated member 114 is movably coupled (e.g., slidably coupled) to the first elongated member 102. In some examples, the second elongated member 114 has a maximum width greater than a maximum width of the first elongated member 102 in a direction substantially perpendicular to the first direction d1. In some examples, the second elongated member 114 is configured to move over the first elongated member 102.

In some examples, the second elongated member 114 is made of a material similar to a material of the first elongated member 102, such as metallic material. In one or more examples, the spring 108 is made of a metallic material, such as steel. In various examples, the first elongated member 102 and the second elongated member 114 include at least one of aluminum, stainless steel, carbon steel, titanium, and/or metal alloys selected to help provide a balance of strength, weight, and/or corrosion resistance. In some examples, at least one of the first elongated member 102 and the second elongated member 114 is made of a non-metallic material, such as a polymer, fiber-reinforced composite, or glass-filled plastic. In some examples, different materials are selected for the first elongated member 102 and the second elongated member 114 to help tailor stiffness, mass, and/or wear characteristics. In various examples, the spring 108 includes spring steel, stainless steel, and/or other resilient materials configured to repeatedly undergo elastic deformation without permanent set. In some examples, one or more components of the apparatus 100 include surface treatments or coatings, such as anodizing, plating, or polymer coatings, to help improve durability, grip, and/or environmental resistance.

Referring to FIGS. 2A-H, in some examples, the second elongated member 114 is coupled to and/or in contact with an end of the spring 108 and is still configured to move towards the tip 122 of the tool 104 and compress the spring 108 to transfer force through the tool 104 through the tip 122, but the second elongated member 114 does not encompass the tool 104. In some examples, first elongated member 102 includes a connecting member 128. In some examples, the apparatus 100 includes a connecting member 128 that is separate from the first elongated member 102 but is disposed around the first elongated member 102. In one or more examples, the connecting member 128 is fixedly coupled to the first elongated member 102. According to various examples, the connecting member 128 is fixedly coupled to the spring 108 at the first spring end 110. In some examples, the connecting member 128 is made of a material similar to the material of the first elongated member 102 and/or the second elongated member 114.

In some examples, first elongated member 102 is concentric with at least one of: the second elongated member 114, connecting member 128, cap 116, and/or spring 108. In some examples, the connecting member 128 has a maximum width equal to a maximum width of the second elongated member 114. In some examples, the connecting member 128 is not an elongated member, and the maximum width of the connecting member 128 is greater than the length of the third member in the first direction d1.

In some examples, the first elongated member 102 includes a first portion 130 and a second portion 132. In one or more examples, the spring 108 surrounds the second portion 132, and the second portion is fixedly coupled to the connecting member 128. In various examples, the first portion 130 is fixedly coupled to the second spring end 112 and is configured to compress the spring 108 by moving with respect to the second portion 132 in the first direction d1. In one or more examples, the first portion 130 has a width greater than the second portion 132 and is configured to slide over the second portion 132 towards the connecting member 128. In some examples, the connecting member 128 encloses an outer perimeter of the first portion 130. According to various examples, the first spring end 110 is coupled directly to the connecting member 128. In some examples, the second spring end 112 is coupled directly to the second elongated member 114.

In some examples, a ratio of a width of the first portion 130 to a width of the second portion 132 is between and inclusive of 1.01 and 1.5. In some examples, the ratio is approximately 1.3. In some examples, the first portion 130 is shaped similarly to the second portion 132. For example, referring to FIGS. 2A-F, the first portion 130 is a tube that is disposed around at least a portion of the second portion 132, which is substantially cylindrical in shape. In some examples, the first portion 130 is configured to telescope with respect to the second portion 132 and/or move translationally with respect to the second portion 132. In one or more examples, rather than being part of the second elongated member 114, the second portion 132 is a portion of the first elongated member 102. In some examples, the second portion 132 is a portion of the first elongated member 102, and the entire first elongated member 102 is of a monolithic construction. According to one or more examples, the second elongated member 114 at least partially enclosed the second portion 132. In some examples, the second elongated member 114 is configured to telescope with the second portion 132. In some examples, the second elongated member 114 is wider than second portion 132. According to one or more examples, a ratio of a width of the second elongated member to a width of the second portion 132 is between and inclusive of 1.001 and 1.5. In some examples, the ratio is between and inclusive of 1.0001 and 2.0.

In some examples, the second spring end 112, which is opposite to the first spring end 110, is fixedly coupled to the second elongated member 114. Referring to FIGS. 1A and 1B, in some examples, the second spring end 112 is disposed within the second elongated member 114. Referring to FIGS. 2A-E, in other examples, the spring 108 is external to the second elongated member 114, and the second spring end 112 is fixedly coupled to the first portion 130. Referring to FIGS. 1A-B and 2A-E, in some examples, a length of the spring when the spring is at an equilibrium (or non-compressed) position is between and inclusive of not less than 2 centimeters and not greater than 12 centimeters.

Referring to FIGS. 1A and 1B, in some examples, the second elongated member 114 includes an interior portion 134 that fills at least a portion of an interior of the second elongated member 114. In some examples, the interior portion 134 is an internal member of the second elongated member 114. In one or more examples, the interior portion 134 is substantially cylindrically shaped and/or fills a portion of an internal cavity of the second elongated member 114. In various examples, the interior portion 134 is fixedly coupled to the spring proximate to the second spring end 112.

Referring to FIGS. 2A-F, in some examples, the spring 108 is disposed at least partially around an outer circumference of the second elongated member 114. Referring to FIGS. 1A-B, 2A-H, and 3, in some examples, the spring 108 includes not less than 3 and not greater than 50 coils. In various examples, the spring 108 has an outer diameter of not less than 0.5 and not greater than 15 millimeters (“mm”). According to some examples, the spring 108 has an outer diameter of not less than 2 and not greater than 15 mm. In one or more examples, the spring 108 has an equilibrium length of not less than 20 and not greater than 100 mm. In various examples, the spring 108 has an equilibrium length of not less than 20 and not greater than 50 mm. In one or more examples, a ratio of an equilibrium length of the spring 108 to a length of the second elongated member 114 is not less than 0.2 and not greater than 0.8. In one or more examples, a ratio of an equilibrium length of the spring 108 to a length of the second elongated member 114 is not less than 0.1 and not greater than 0.8.

Referring to FIGS. 1A-B, 2A-D, and 2G, in some examples, the apparatus 100 includes a cap 116 disposed over an end 118 of the second elongated member 114. In some examples, the cap 116 is removably coupled to the end 118. In other examples, the cap 116 is fixedly coupled the end 118 and/or forms a monolithic construction with the second elongated member 114. In one or more examples, the cap 116 provides a greater surface area for the user to strike in, helping to improve ease of aim and distribution of force. In some examples, the cap 116 has a maximum width w1 greater than a maximum width w2 of the second elongated member 114. In various examples, a ratio of the maximum width of the cap 116 to a maximum width of the second elongated member 114 is not less than 1.001 and not greater than 3.

Referring to FIGS. 1A-B, 2A-G, and 3, in some examples, the apparatus 100 includes a line 120 threaded through the cap 116 and disposed within the second elongated member 114. In some examples, the line 120 is a flexible elongated member, such as a thread, a string, a cord, or the like. Referring to FIG. 2G, in some examples, the line 120 is threaded through the cap 116 and extends through the second elongated member 114. Referring to FIGS. 1A, 1B, and 2E, according to some examples, the line 120 extends into the first elongated member 102. In some examples, an end of the line 120 is fixed within the first elongated member 102.

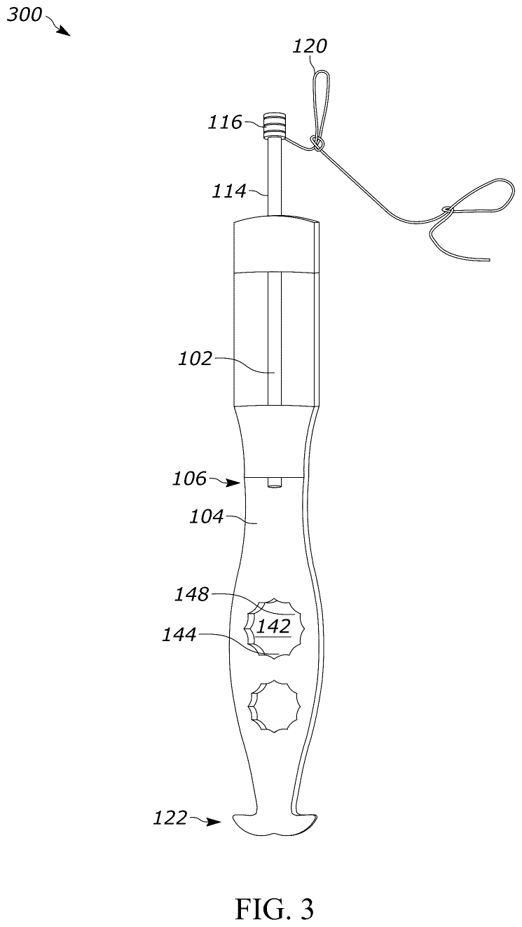

In various examples, the line 120 is made of a synthetic fiber that is substantially heat resistant. In some examples, the line 120 is knotted to help prevent the second elongated member 114 and the cap 116 from sliding. In some examples, the line 120 limits the range of movement of the second elongated member 114. In some examples, the line 120 maintains connection and/or contact between the second elongated member 114 and the first elongated member 102 when the spring 108 is in an equilibrium position. Referring to FIG. 3, in some examples, the line 120 includes one or more loops configured to be clipped to a carabiner and/or harness.

In some examples, the apparatus 100 includes elements other than the line 120 that are configured to help limit the range of movement of the second elongated member 114. In some examples, an end of the second elongated member includes a lip that corresponds to a lip on the first elongated member 102. In some examples, a cap couples to the first elongated member 102 to cover the lip of the second elongated member 114. In some examples, each of the second elongated member 114 and the first elongated member 102 are coupled to an end of the spring 108.

Referring to FIGS. 1A and 1B, in some examples, the line 120 runs alongside and/or within the first elongated member 102. In various examples, the line 120 is coupled to the first elongated member 102. In some examples, the line 120 includes a first stopper 138 (e.g., a knot) proximate to the end 118 of the second elongated member 114 and a second stopper 140 proximate to the first elongated member 102. In some examples, one or more of the first stopper 138 and/or the second stopper 140 is attached to the cap 116 and/or the first elongated member 102 via an adhesive, such as an epoxy resin.

FIG. 2E is a cross-sectional view along the plane ‘A’ of an end and tool 104 of the lodged object removal apparatus 100 of FIG. 2A, according to various embodiments. Referring to FIG. 2E, in some examples, the line 120 is threaded through an interior of the first elongated member 102, and the line 120 is threaded through the first elongated member 102. In various examples, the apparatus 100 includes an inner tube 146 within the first elongated member 102 through which the line 120 is threaded. In some examples, the inner tube 146 is substantially hollow. According to some examples, the inner tube 146 is shaped substantially similar to the first elongated member 102. In some examples, the inner tube 146 is fixed within the first elongated member 102. According to some examples, the first elongated member 102 is substantially concentric with the inner tube 146.

According to various examples, the line 120 extends through an opening in the inner tube 146. In some examples, the apparatus 100 includes a stopper 140 disposed within the first elongated member 102 and connected directly to the line 120. In some examples, the stopper 140 has a maximum width that is greater than a maximum width of the opening of the inner tube 146, preventing the stopper 140 from slipping into the inner tube 146. In various examples, the stopper 140 has a maximum width that is sufficient to form a friction fit with the inner walls of the inner tube 146, such that the line 120 is retained within the first elongated member 102. In some examples, the inner tube 146 is removable from the first elongated member 102. According to some examples, the stopper 140 and the line 120 are of a monolithic construction. In some examples, the stopper 140 includes at least one of a knot formed in the line 120, a magnetic component, a bead, plug, or ferrule fixedly coupled to the line 120, a molded enlargement formed on the line 120, a crimped or swaged component, an elastomeric element configured to radially compress against the inner walls of the inner tube 146, a threaded component, or a collapsible or deformable element that expands after insertion through the opening of the inner tube 146. In some examples, the stopper 140 includes a disc-shaped, spherical, conical, or tapered geometry configured to resist movement through the inner tube 146.

FIG. 2G is a side view of an end and end cap 116 of the lodged object removal apparatus 100 of FIG. 2A, according to various embodiments. Referring to FIG. 2G, in some examples, the second elongated member 114 includes an exterior tube 144, the interior portion 134 includes an interior tube, and the end cap 116 also includes a tubular portion. In some examples, each of the exterior tube 144, interior portion 134, and end cap 116 are of a different circumference. In some examples, the exterior tube 144, interior portion 134, and end cap 116 are concentric with each other. In some examples, the line 120 is threaded through the cap 116 and the interior portion 134 at an approximately 90-degree angle.

In some examples, the cap 116 is secured to the second elongated member 114 via one or more elements configured to mate with elements of the second elongated member 114, such as threads or a push pin that locks the cap 116 in place. In some examples, the cap 116 can be placed on the end 118 of the second elongated member 114 and then rotated (e.g., with a 90 degree turn) to lock the cap 116 in place. In other examples, the cap 116 forms a friction fit with the second elongated member 114. In some examples, the cap 116 is fixed to the second elongated member 114 via an adhesive, such as glue.

Referring to FIGS. 2A-D and FIG. 2H, in some examples, the apparatus 100 is collapsible such that the apparatus 100 can be transported and/or stored with the spring 108 in a compressed position. In some examples, the apparatus 100 includes a locking mechanism 202, such as a pin, to reduce the overall length of the apparatus 100 for storage and/or transportation. FIG. 2H is a cross-sectional view of the lodged object removal apparatus 100 along a plane parallel to the plane ‘B’ shown in FIG. 2A, with a locking mechanism 202 in place, to compress the object removal apparatus 100 in a storage position, as shown in FIG. 2D. As illustrated in FIG. 2H, in some examples, the locking mechanism 202 extends through a thickness of the second elongated member 114 and is configured to engage with the first elongated member 102 to hold the second elongated member 114 in a position to maintain elastic deformation (e.g., compression) of the spring 108. In some examples, the locking mechanism 202 includes a pin that is insertable through aligned apertures formed in the first elongated member 102 and the second elongated member 114. According to some examples, the locking mechanism 202 includes a spring-biased detent, latch, or plunger that automatically engages when the second elongated member 114 reaches a predetermined spring 108 compression position. In some examples, the locking mechanism 202 is manually releasable by a user to transition the apparatus 100 from the storage position to an operational position.

Referring to FIG. 3, examples of the present disclosure include an apparatus 300 having an elongated tool 104, according to various embodiments. In some examples, the apparatus 300 is an embodiment of the apparatus 100. In some examples, the apparatus 300 includes parts that are substantially similar to those described above in reference to FIGS. 1A-B and 2A-H.

In some examples, the tool 104 includes a tip 122 with curved portions that are configured to grip a lodged object. In various examples, the tool 104 includes one or more openings through a thickness of the tool that are configured to fit around portions of a lodged object. In some examples, the openings function similarly to an opening of a wrench and can help to dislodge an object via friction and rotation.

As shown in FIG. 3, in some examples, the tool 104 includes an opening 142 extending through a thickness of the tool 104. According to various examples, the tool 104 includes a plurality of ridges 148 projecting radially inward into the opening 142. The plurality of ridges 148 are spaced circumferentially around the opening. In some examples, the ridges 148 include teeth configured to grip an object.

Referring to FIGS. 1A-B and 3, in some examples, the second elongated member 114 is at least partially disposed within the tool 104. In some examples, the second elongated member 114 is not fixed with respect to the tool 104 and is configured to move translationally with respect to the tool 104 by telescoping with the first elongated member 102, which is fixed with respect to the tool 104.

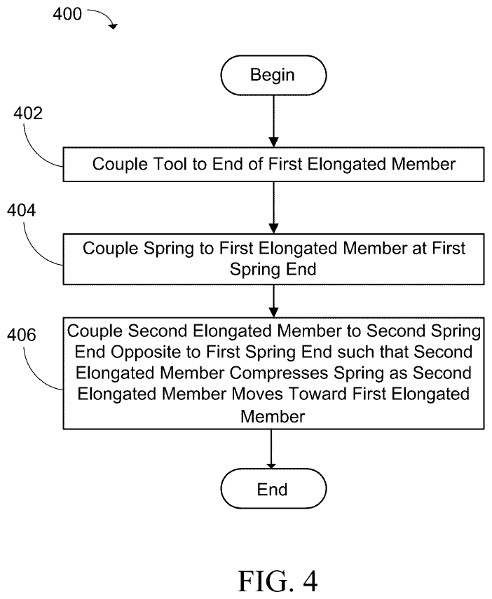

Referring to FIG. 4, examples of the present disclosure include a method 400 of manufacturing a lodged object removal apparatus 100. In some examples, the method 400 includes a step 402 of coupling a tool 104 to an end 106 of a first elongated member 102. The method 400 includes a step 404 of coupling a spring 108 to the first elongated member 102 at a first spring end 110 of the spring 108. The method 400 includes a step 406 of coupling a second elongated member 114 to a second spring end 112 of the spring 108 opposite to the first spring end 110 such that the second elongated member 114 compresses the spring 108 as the second elongated member 114 moves toward the first elongated member 102.

Examples of the present disclosure also include a method of using the apparatus 100. The method includes positioning the tool 104 in contact with and/or proximate to the lodged object 124 and striking the end cap 116 (e.g., with the palm of a user's hand) to move the second elongated member 114 and apply force through the tool 104, through the tip 122 of the tool 104, and to the lodged object 124.

The present invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a first elongated member;
a tool coupled to an end of the first elongated member;
a spring comprising a first spring end coupled to the first elongated member and a second spring end opposite to the first spring end; and
a second elongated member coupled to the second spring end such that the second elongated member moving toward the first elongated member causes elastic deformation of the spring.

2. The apparatus of claim 1, wherein the spring is disposed within the second elongated member.

3. The apparatus of claim 1, further comprising a locking mechanism extending through a thickness of the second elongated member and configured to engage with the first elongated member to hold the second elongated member in a position to maintain elastic deformation of the spring.

4. The apparatus of claim 1, further comprising a cap disposed over an end of the second elongated member, the cap having a maximum width greater than a maximum width of the second elongated member.

5. The apparatus of claim 4, further comprising a line threaded through the cap and extending through the second elongated member and into the first elongated member, wherein an end of the line is fixed within the first elongated member.

6. The apparatus of claim 5, further comprising:
an inner tube disposed within the first elongated member and comprising an opening, wherein the line extends through the inner tube and through the opening; and
a stopper disposed within the first elongated member and connected directly to the line, wherein the stopper has a maximum width greater than a maximum width of the opening.

7. The apparatus of claim 6, wherein the first elongated member is substantially concentric with at least one of the inner tube, the second elongated member, and the cap.

8. The apparatus of claim 1, wherein the second elongated member is configured to strike the first elongated member, transferring a momentum force to the first elongated member and to a tip of the tool located beyond the first elongated member.

9. The apparatus of claim 1, wherein the tool comprises a tip located beyond the first elongated member and the second elongated member is configured to transfer a momentum force to the first elongated member and to the tip by moving towards the first elongated member.

10. The apparatus of claim 1, wherein the tool comprises at least one of a hook, a pick, a key, a hammer head, and/or a knife.

11. The apparatus of claim 1, wherein the first elongated member is at least partially disposed within the second elongated member.

12. The apparatus of claim 1, wherein the second elongated member is configured to move translationally with respect to the first elongated member.

13. The apparatus of claim 1, wherein the first elongated member and the tool are of a monolithic construction.

14. The apparatus of claim 1, wherein the first elongated member comprises a first portion and a connecting member fixedly coupled to and enclosing an outer perimeter of the first portion, wherein the first spring end is coupled directly to the connecting member and the second spring end is coupled directly to the second elongated member.

15. The apparatus of claim 14, wherein the first elongated member further comprises a second portion coupled to the connecting member, wherein:
the spring surrounds the second portion; and
the second elongated member at least partially encloses the second portion and is configured to telescope with the second portion.

16. The apparatus of claim 15, wherein a ratio of a width of the second elongated member to a width of the second portion is between and inclusive of 1.001 and 2.0.

17. The apparatus of claim 1, wherein the tool comprises:
an opening extending through a thickness of the tool; and
a plurality of ridges projecting radially inward into the opening, wherein the plurality of ridges are spaced circumferentially around the opening.

18. The apparatus of claim 1, wherein the second elongated member is disposed at least partially within the tool and is configured to move translationally with respect to the tool.

19. An apparatus, comprising:
a first elongated member;
a tool coupled to an end of the first elongated member and comprising a tip located beyond the first elongated member;
a spring comprising a first spring end coupled to the first elongated member and a second spring end opposite to the first spring end; and
a second elongated member within which the first elongated member is at least partially disposed, wherein the second elongated member is configured to move translationally with respect to the first elongated member and is coupled to the second spring end such that the second elongated member moving toward the first elongated member causes elastic deformation of the spring and a transfer of a momentum force to the first elongated member and to the tip.

20. An apparatus, comprising:
a first elongated member;
a tool coupled to an end of the first elongated member, the tool comprising a tip located beyond the first elongated member and at least one of: a hook, a pick, a key, a hammer head, and/or a knife;
a spring comprising a first spring end coupled to the first elongated member and a second spring end opposite to the first spring end;
a second elongated member within which the first elongated member is at least partially disposed, wherein the second elongated member is configured to move translationally with respect to the first elongated member and is coupled to the second spring end such that the second elongated member moving toward the first elongated member causes elastic deformation of the spring and a transfer of a momentum force to the first elongated member and to the tip;
a locking mechanism extending through a thickness of the second elongated member and configured to engage with the first elongated member to hold the second elongated member in a position to maintain elastic deformation of the spring;
a cap disposed over an end of the second elongated member, the cap having a maximum width greater than a maximum width of the second elongated member;
a line threaded through the cap and extending through the second elongated member and into the first elongated member, wherein an end of the line is fixed within the first elongated member;
an inner tube disposed within the first elongated member and comprising an opening, wherein the line extends through the inner tube and through the opening; and
a stopper disposed within the first elongated member and connected directly to the line, wherein the stopper has a maximum width greater than a maximum width of the opening,
wherein the first elongated member is substantially concentric with respect to at least one of the inner tube, the second elongated member, and the cap.
